(19) United States
(12) Patent Application Publication
(10) Pub. No.: US 2005/0044910 A1
(43) Pub. Date: Mar. 3, 2005

(54) Tactile-encoded combination lock

(76) Inventor: Michael L. Sloan, Chico, CA (US)

Correspondence Address: R. MICHAEL WEST LAW OFFICES OF;R. MICHAEL WEST, A PROFESSIONAL CORPORATION, 455 CAPITOL MALL; SUITE 405, SACRAMENTO, CA, 95814-4603, US

(21) Appl. No.: 10/648,127

(22) Filed: Aug. 25, 2003

(51) Int. Cl. E05B 17/00

(52) U.S. Cl. 70/446; 70/202; 70/30

(57) ABSTRACT

A tactile-encoded combination lock including a housing and a closure piece. The combination lock may be configured as general locking device or as a special locking device for use with guns. The housing includes an accessible tactile-encoded circular dial, operably connected to an internal locking mechanism. The dial includes a tactile dial index on its outer periphery. A tactile registration index and at least two tactile rotational position indices are also provided on the housing, in spaced relation from the outer periphery of the dial. The locking mechanism includes a coupling means receiver. When the lock is in a locked condition, the closure receiver is interconnected to coupling means, extending from the closure piece. Upon proper entry of the combination, using the tactile input from the dial index, the registration index, and the indices, the encoded combination is entered, releasing the coupling means and the closure piece.

### BACKGROUND OF THE INVENTION

1. Field of the Invention

The invention relates generally to rotary combination locks which can be unlocked without the user having to view visual information contained on a lock dial. More specifically, the present invention contemplates a tactile-encoded rotary combination lock which may be configured either as a general locking device or as a special locking device for use with guns.

2. Description of the Prior Art

The prior art teaches both tactile and non-numeric encoded dials for use with lock mechanisms. For example, in U.S. Pat. No. 5,775,252, issued to Kilgore, a rotary dial having tactile indicia is shown. Kilgore employs a plurality of tactile-sensed position indicators arranged around the periphery of the dial. Each of the position indicators is comprised of a rod supporting a bar. The bar of each position indicator varies in position in accordance with an hour hand position on a clock face. Taking into consideration the information imparted by the hour hand position, the user can determine the rotational position of the dial as it is manipulated.

In U.S. Pat. No. 4,582,251, granted to Odom, Jr. et al., a space thermostat for the sight handicapped is shown. Raised numbers and raised line marks are provided in spaced relation on the upper portion of a stationary cover ring. These raised numbers and marks correspond to a temperature range. A raised pointer is provided on the edge of the centrally positioned rotatable dial, or knob. A sight handicapped person can feel the temperature numbers and the intermediate line marks, and move the pointer so it corresponds to the desired temperature.

A braille finder for use with a dial on a combination lock, is disclosed in U.S. Pat. No. 3,536,017, issued to Lucas. The surface of a rotatable knob is provided with braille characters which can be lined up with a stationary reference or index.

A daylight fluorescent color combination lock with optional additional indicia is shown in U.S. Pat. No. 5,522,243, granted to Kusmiss. The additional nonnumerical indicia may comprise geometric patterns or pictures of different animals. Making the indicia relatively large relative to the other parts of the lock aids the visually impaired user in accurately identifying the desired pattern, color, or marking.

The need exists, however, for a tactile-encoded combination lock which can be used without any reliance upon visual features, and which works in a manner closely analogous to present rotary combination locks.

The need further exists for a tactile-encoded combination lock having marking indicia which are readily sensed and understood without any special training or knowledge on the part of the user.

The need also exists for a tactile-encoded combination lock having marking indicia which may be increased or decreased in number, and moved in relative position with respect to each other, to provided greater or lesser complexity in the tactile-encoded release combination to suit the application.

The need also exists for a tactile-encoded combination lock having a housing and a detachable closure piece, adapted to couple over and within the trigger guard of a gun, thereby preventing firing of the gun until the housing and the closure piece are removed.

The need also exists for a tactile-encoded combination lock having a housing and a detachable closure piece, with the closure piece being adapted to pass through the magazine cavity and the shell chamber of a gun, thereby preventing loading and firing the gun until the detachable closure piece is removed.

These and other objects will be described below in the drawings and the detailed description of the preferred embodiment to follow.

### SUMMARY OF THE INVENTION

The tactile-encoded combination lock of the present invention includes a housing and a closure piece. If the combination lock is configured as a general locking device, the closure piece has two ends which enter the housing, one end being attached to the housing at all times and the other end being detachable from the housing upon entry of the encoded release combination.

If the combination lock is configured as a special locking device for use with guns, two embodiments of the invention are disclosed, each having different versions of their respective closure pieces. In the first embodiment of the gun lock, the closure piece is entirely detachable from the housing. To install this first embodiment on a gun, the housing is placed over one side of the trigger guard and the closure piece is installed over the other side of the trigger guard. A coupling rod and a stabilization rod, extending from the closure piece, couple within the housing. The trigger guard and the trigger are completely covered, preventing use of the gun.

In the second embodiment of the gun lock, the closure piece is partially detachable from the housing. Preferably, the closure piece is a flexible cable, having one end permanently affixed to the housing and the other end provided with a coupler. After the free end of the cable is passed through the empty magazine of a gun, and emerges from the exposed side of the shell chamber, the coupler end of the cable is inserted into the housing to engage components of the locking mechanism. The presence of the cable in the magazine and the shell chamber prevent use of the gun.

Yet another important aspect of the combination lock of the present invention is a tactile-encoded dial and an associated locking mechanism, located respectively, on and in the housing. The rotatable dial is circular, and lies over a front portion of the exterior wall of the housing. The dial includes a tactile dial index on its outer periphery. A tactile registration index is provided on the exterior wall of the housing at the 0° position, or whatever location may be designated the combination entry starting point. The registration index is located radially outwardly from the outer periphery dial, but sufficiently close that the user's finger point can touch both the dial index and the registration index simultaneously.

At least two tactile rotational position indices are also provided on the exterior wall of the housing, in spaced relation from the outer periphery of the dial. These rotational position indices are located at pre-determined angles of rotation preferably on either side of the registration index. More tactile rotational position indices may be added, say at 45°, 90°, 180°, 225°, 270°, and 315°, in the event a more complex combination is desired.

A dial shaft extends from the inner or rear side of the dial to the locking mechanism. In this way, the extent and direction of rotation of the dial is imparted to the locking mechanism. A closure piece receiver is operably connected to the locking mechanism. The closure piece receiver is interconnected to a closure rod or a cable coupler, extending from the closure piece, when the lock is in a locked position.

By moving the dial index into close proximity to the registration index, the user establishes a starting point for entry of the encoded combination. The encoded combination is entered in exactly the same fashion as with a conventional combination lock, except the rotational position indices and the registration index are used as tactile references when entering the encoded combination. Upon proper entry of the combination, the locking mechanism releases the closure receiver, and the closure rod or the cable coupler are released.

### BRIEF DESCRIPTION OF THE DRAWINGS

FIG. 1 is an exploded left front perspective of the tactile-encoded combination gun lock of the present invention, showing the housing and the detachable closure piece;

FIG. 2 is a top plan view of the gun lock shown in FIG. 1, but with the housing and the closure piece coupled together;

FIG. 3 is a side elevational view of a handgun fitted with the gun lock of FIG. 1;

FIG. 4 is a right front perspective view of a tactile-encoded combination lock of the present invention;

FIG. 5 is a side elevational view of a second handgun, fitted with a second embodiment of a tactile-encoded combination gun lock of the present invention;

FIG. 6 is a front elevational view of the gun lock of FIG. 5 showing a first rotational position for the dial;

FIG. 7 is a view as in FIG. 6, but showing a second rotational position for the dial;

FIG. 8 is a view as in FIG. 6, but showing a third rotational position for the dial; and,

FIG. 9 is a view as in FIG. 6, but showing a fourth rotational position for the dial, with the locking mechanism unlocked and the closure piece withdrawn.

### DETAILED DESCRIPTION OF THE PREFERRED EMBODIMENT

Turning now to the drawings, and in particular to FIG. 1, a tactile-encoded combination gun lock 11 includes a lock housing 12 having an exterior wall 13. A combination lock mechanism 14, shown in broken line, is provided within lock housing 12. Lock mechanism 14 includes a rotatable dial shaft 16, having one end interconnected to the lock mechanism and the other end passing through wall 13 and extending exteriorly from the housing 12.

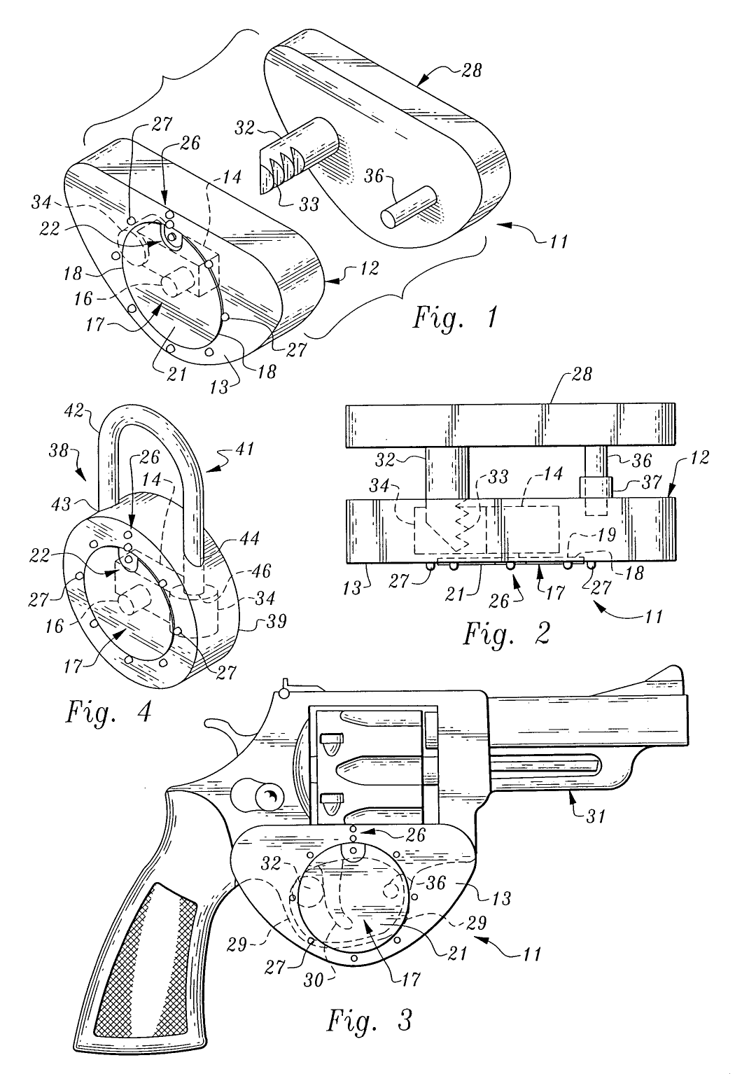

A circular, rotatable dial 17 overlies a portion of exterior wall 13. For durability and ease of use of the lock 11, a shallow circular recess 18 may be provided in wall 13 to accommodate dial 17. As shown in FIGS. 1 and 2, dial 17 has an inner side 19 and an outer side 21. When dial 17 is mounted within recess 18, its outer side 21 is flush or nearly flush with respect to the exterior wall 13. The center of the inner side 19 is interconnected to the exteriorly extending end of the dial shaft 16. In this manner, the extent and direction of rotation imparted to dial 17 is communicated through shaft 16 to lock mechanism 14.

The outer side 21 of dial 17 is provided with a tactile dial index 22. Index 22 includes a nub 23 located within the center of a U-shaped depression 24, located on the outer periphery of the dial 17. Equivalent constructions for the dial index 22 include physical features which are either protruding or recessed, or which present a localized area having surface characteristics readily detectable by touch.

A tactile registration index 26 is provided on the exterior wall of the housing, immediately above the dial 17. The registration index 26 is located in spaced relation from the outer periphery of dial 17, but is arranged sufficiently close to the dial so that the user's finger tip can simultaneously touch both the dial index 22 and the registration index 26. In the present construction, registration index 26 is comprised of two nubs, to distinguish it from other tactile indicia used. However, a single large nub, or another physical features which is distinctive to the touch would function equally well for index 26.

At least two tactile rotational position indices 27 are also located on the exterior wall 13 of the lock housing 12. Tactile indices 27 are spaced a slight distance outwardly from the outer periphery of the dial, in similar fashion as registration index 26. The tactile indices 27 are also arranged in pre-determined angles of rotation from the registration index 26. Preferably, tactile indices 27 are located on either side of index 26, a rotational extent sufficient to distinguish their location from index 26. Although this rotational extent is not critical, a minimum of 10°, or so, is believed sufficient.

If the encoded combination for the combination lock is very simple, only two tactile indices 27 may be sufficient. However, more tactile indices 27 may be added at any location desired, to provide more tactile resolution and to provided more complex combinations of rotational excursions before the combination is satisfied. For example, in FIG. 1, tactile indices 27 are provided at 45°, 90°, 180°, 225°, 270°, and 315°. It should be pointed out that while the tactile indices 27 in the form of protruding nubs are the preferred form of tactile indicia, other equivalent tactile structures, as discussed above, could be used instead.

The second major component of the combination gun lock 11 is a closure piece 28. Housing 12 and closure piece 28 are sized and configured to cover opposite sides of the trigger guard 29 and a trigger 30 of a handgun 31, as shown in FIG. 3. Means are provided for the purpose of selectively coupling housing 12 and closure piece 28 together. In gun lock 11, that coupling means comprises a coupling rod 32 extending from closure piece 28. Coupling rod 28 includes a plurality of notches 33 on its outer end. for engagement with a coupling means receiver 34 in the lock mechanism 14. Coupling means receiver 34 includes a latching mechanism interconnected to lock mechanism 14, so that coupling rod 28 is held captive in receiver 34 when mechanism 14 is locked are released when mechanism 14 is unlocked.

To prevent either the housing or the closure piece from being rotated with respect to each other, a stabilization rod 36 is provided. Rod 36 extends in perpendicular fashion from the inner side of closure piece 28. As shown in FIG. 2, a tubular receiver 37 is provided on the inner side of housing 12 to accommodate the outer end of stabilization rod 36.

Resilient rubber or foam pieces (not shown) may be provided both on the inner side of the housing 12 and on the inner side of the closure piece 28. The use of such pieces will protect the surface of the handgun 31, and will also ensure a snug fit when housing 12 and closure piece 28 are coupled together in locking relation over trigger guard 29.

The present invention may also be used advantageously as a tactile-encoded combination lock 38, for more general applications. This construction, shown in FIG. 4, is identical in most respects to the gun lock 11 described above. Therefore, where the same structural features are used in this construction, the same descriptive numerals used for the gun lock 11 are used herein.

The combination lock 38 includes a lock housing 39 having the same general configuration as a conventional combination lock. The principal differences lie in the tactile-encoded features of the present invention. The rotatable dial 17, including tactile dial index 22, is identical to that previously described. Also identical are registration index 26 and tactile rotational position indices 27. Dial 17 is supported for rotation about its axis by dial shaft 16, in turn, coupled to combination lock mechanism 14. A coupling means receiver 34, operably connected to mechanism 14 is also provided.

Combination lock 38 also includes closure piece 41, comprising a U-shaped rod 42. As with a conventional combination lock, one end 43 of rod 42 is partially restrained within housing 34. End 43 is allowed rotational and axial movement, but it cannot be removed from the housing. The other end 44 of the rod 42 includes coupling means 46, which may be selectively locked within or removed from the coupling means receiver 34. Coupling means may be one or more notches or a detent.

In the locking procedure, combination lock 38 requires that the closure piece 41 be located to restrain another element (not shown), such as a hasp, links of a chain, or some other structure, and then insert end 44 into coupling means receiver 34. In the unlocking procedure, the dial 17, in combination with utilization of the various registration indices and the rotational position indices 27, is used to enter the proper encoded combination, with sole reliance upon tactile references. Then, lock housing 39 is pulled away from the restrained element, and the end 44 of rod 42 is freed from the coupling means receiver 34.

Yet another embodiment of the present invention, a tactile-encoded combination gun lock 47, is shown in FIGS. 5-9. As with combination lock 38, this construction shares many structural and operational features with gun lock 11, described above. Thus, where applicable, the same descriptive numerals which were used to describe gun lock 11, will be used herein to describe the identical features of gun lock 47.

Gun lock 47 includes a lock housing 48 and a closure piece 49. Although square in front elevation in the drawings, the configuration of housing 48 is not critical and could be circular, rectangular, or any other configuration desired. Housing 48 includes a rotatable dial 17, provided with a tactile dial index 22, identical to that previously described. Similarly provided identical features are registration index 26 and tactile indices 27. Dial 17 is supported for rotation about its axis by a dial shaft 16 which is coupled to a combination lock mechanism 14 and an associated coupling means receiver 34. For purposes of clarity, these latter three features, which are internal to housing 48, are not shown in FIGS. 5-9. However, they are identical to those corresponding features shown in the previous two embodiments.

Closure piece 49 comprises a flexible cable 51, which may be a foot or so in length. It is also contemplated that cable 51 could be lengthened to say 4 or 5 feet or more, where it could be used to lock bicycles or other apparatus requiring a long, flexible, and removable restraint element. An attached end 52 of the cable is permanently affixed to housing 48. A free end 53 of cable 51 includes coupling means 54, which is detachably connected to internal coupling means receiver 34. Coupling means 54 includes notches or teeth 56 on its end, which are either engaged or disengaged with receiver 34, depending upon whether the combination lock mechanism is locked or unlocked.

In use, the free end 53 of flexible cable 51 is inserted through a magazine cavity 57 of a hand gun 58. The cable 51 is further passed through the shell chamber 59, where it emerges from the hand gun 58. Inserting the coupling means 54 of the free end 53 into the lock housing 48, secures 5 the cable within operative areas of the hand gun 58. Unable to insert either a magazine in the magazine cavity 57 or a shell into the shell chamber 59, the hand gun 58 is effectively disabled.

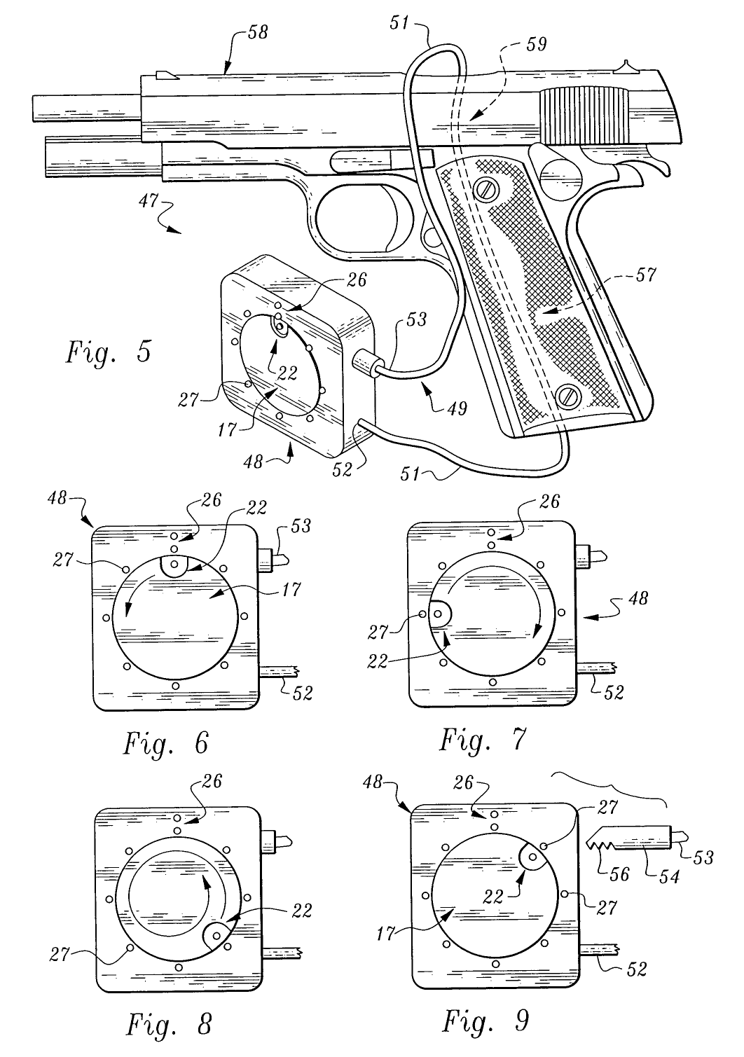

FIGS. 6-9 illustrate a tactile-encoded unlocking procedure, not only for the gun lock 47, but also for the combination lock 38 and the gun lock 11.

By way of example only, FIG. 1 shows a first step with the dial index 22 at a 0° “start position”, where index 22 and index 26 are in close proximity. This step presumes that the user has already “cleared” the lock mechanism, by rotating dial 17 several times in clockwise fashion. In the next step, shown in FIGS. 6 and 7, dial 17 is rotated 90° counter-clockwise, to the second of the two tactile indices 27. This effects the 270° rotational position for the index 22, shown in FIG. 7.

In the next step, the dial 17 is rotated 225° in a clockwise fashion. Making reference to FIGS. 7 and 8, the dial 17 is rotated clockwise past the tactile indices 27 and the registration index 26, until it reaches the 135° rotational position. Detecting the 135° rotational position by knowing that it is the third tactile index 27 to the right hand, or clockwise side of registration index 26, the user now rotates the dial 17 a total of 450° in a counter-clockwise fashion. In this process, the user passes by and detects the registration index 26, and knows that the goal of the further counter-clockwise rotation is a tactile index 27 at the an end position of 45°.

It is evident that the tactile-encoded combination may be interpreted by the user, by counting left-hand or right hand indices 27, about either side of registration index 26, or by visualizing rotational positions and rotational directions based upon the fact that the tactile indices 27 are spaced 45° from each other. Irrespective of the mental process used, either alone or in combination, the user comprehends and applies the tactile-encoded combination solely without reference to visual features. In addition, application of the tactile-encoded combination is made without the user having to learn braille, or some other specialized tactile code, to unlock any of the combination locks described herein.

1. A tactile-encoded combination lock comprising:
a. a lock housing having an exterior wall;
b. a combination lock mechanism within said lock housing, said lock mechanism including a rotatable dial shaft having one end interconnected to said mechanism and the other end passing through said wall and extending exteriorly from said housing;
c. a closure piece having coupling means, in which said coupling means is connected to said lock mechanism in a locked position, and in which said coupling means is detached from said lock mechanism in an unlocked position;
d. a circular dial, said dial having an inner side and an outer side, a central portion of said inner side being interconnected to said other end of said dial shaft, said outer side including a tactile dial index on an outer periphery thereof, said dial overlying a portion of said exterior wall;
e. a tactile registration index on said exterior wall of said housing, said registration index being arranged outwardly in spaced relation from said outer periphery of said dial; and,
f. at least two tactile rotational position indices on said exterior wall of said housing, said rotational position indices being arranged outwardly in spaced relation from said outer periphery of said dial, said rotational position indices further being arranged in predetermined angles of rotation from said registration index.

2. A combination lock as in claim 1 in which said tactile registration index is located at a 0 degree rotational position.

3. A combination lock as in claim 2 in which said pre-determined angles of rotation are at least 10 degrees clockwise and at least 10 degrees counter-clockwise from said tactile registration index.

4. A combination lock as in claim 1 in which said housing and said closure piece are sized and configured to fit over both sides of a trigger guard of a gun.

5. A combination lock as in claim 4 in which said coupling means comprises a coupling rod extending from said closure piece, said rod having a plurality of notches for engagement by said lock mechanism.

6. A combination lock as in claim 5 further including a stabilization rod extending from said closure piece, and in which said housing includes a receiver for an end of said stabilization rod.

7. A combination lock as in claim 1 in which said closure piece comprises a flexible cable, one end of said cable being attached to said housing, the other end of said cable having said coupling means detachably connected to said lock mechanism.

8. A combination lock as in claim 7 further including a plurality of notches in said coupling means.

9. A tactile-encoded combination lock comprising:
a. a lock housing having an exterior wall;
b. a closure piece having coupling means extending therefrom;
c. a combination lock mechanism within said lock housing, said lock mechanism including a coupling means receiver;
d. a circular dial, said dial having an inner side and an outer side, said inner side being operably interconnected to said lock mechanism, said outer side including a tactile dial index on an outer periphery thereof, said dial overlying a portion of said exterior wall;
e. a tactile registration index on said exterior wall of said housing, said registration index being arranged outwardly in spaced relation from said outer periphery of said dial; and,
f. at least two tactile rotational position indices on said exterior wall of said housing, said rotational position indices being arranged outwardly in spaced relation from said outer periphery of said dial, said rotational position indices further being arranged in predetermined angles of rotation from said registration index.

10. A combination lock as in claim 9 in which said closure piece comprises a U-shaped rod, one end of said rod being restrained within said housing but allowing rotatable and axial movement, the other end of said rod including said coupling means, said coupling means being selectively locked within or removable from said coupling means receiver.

11. A combination lock as in claim 9 in which said closure piece comprises a plate having a planar inner side, and in which said coupling means comprises a coupling rod extending perpendicularly from said inner side, said coupling rod having a plurality of notches on an outer end thereof, and further including a stabilization rod also extending from said inner side, said stabilization rod being substantially parallel to and in spaced relation from said coupler rod.

12. A combination lock as in claim 11 in which said housing includes a receiver for an end of said stabilization rod.

13. A combination lock as in claim 9 in which said closure piece comprises a cable, said cable having one end affixed to said housing and the other end including said coupling means.

14. A combination lock as in claim 13 in which said coupling means includes a plurality of notches.

15. A combination lock as in claim 9 in which said tactile dial index comprises a depressed region including a nub in the center thereof.

16. A combination lock as in claim 9 in which said tactile registration index comprises a pair of protruding nubs arranged in vertically stacked relation.

17. A combination lock as in claim 9 including a plurality of said rotational position indices located at pre-determined angles of rotation on either side of the registration index at 45°, 90°, 180°, 225°, 270°, and 315°.

18. A combination lock as in claim 9 in which said tactile registration index is located at a 0 degree rotational position.

19. A combination lock as in claim 9 in which said pre-determined angles of rotation are at least 10 degrees clockwise and at least 10 degrees counter-clockwise from said tactile registration index.
